(19) United States
(12) Patent Application Publication
(10) Pub. No.: US 2010/0083770 A1
(43) Pub. Date: Apr. 8, 2010

(54) PROCESS AND DEVICE FOR CONTINUOUS MEASUREMENT OF A DYNAMIC FLUID CONSUMPTION

(75) Inventors: Karl Köck, Krottendorf-Gaisfeld (AT); Michael Cernusca, Judendorf (AT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: AVL List GMBH

(21) Appl. No.: 12/449,380

(22) PCT Filed: Jan. 30, 2008
(86) PCT No.: PCT/EP2008/051080

§ 371 Date: Oct. 26, 2009

(30) Foreign Application Priority Data
Feb. 5, 2007 (AT) GM 69/2007

(51) Int. Cl. G01F 1/34; G01F 1/84

(52) U.S. Cl. 73/861.357; 73/861.42

(57) ABSTRACT

A process for continuous measurement of a dynamic fluid consumption, particularly fuel consumption, uses a continuously working flow rate sensor (7) with variable pressure drop, preferably a mass flow sensor, whereby the pressure downstream of the flow rate sensor (7) is determined for controlling the transport of fluid.

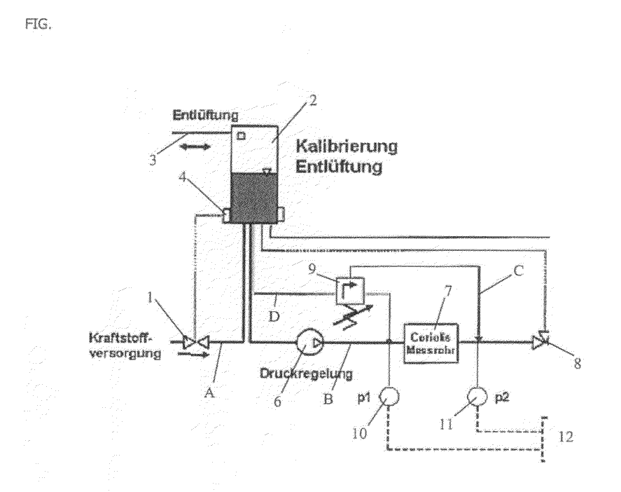

In order to make a continuous, precise, and also chronologically highly resolved measurement of consumption and the highly dynamic determination of the flow rate value possible with a design that is as simple as possible, at least at one point in time, the pressure directly upstream of the flow rate sensor (7), the difference of the two pressure values is also determined, and based on this difference, a value for the flow rate of the fluid is determined.

The invention concerns a process for continuous measurement of a dynamic fluid consumption, particularly fuel consumption with a continuously working flow rate sensor with variable pressure drop, preferably a mass flow sensor, whereby the pressure downstream of the flow rate sensor is identified and used for controlling the transport of fluid, as well as a device for continuous measurement of a dynamic fluid consumption, particularly fuel consumption, comprising a tank, if needed a conditioning system, as well as preferable a controllable pump, a continually working flow rate sensor for the liquid, preferably a Coriolis sensor, as well as a pressure sensor directly downstream of a flow rate sensor, the outlet of which is connected with at least one control unit for the fluid flow, for example, a controllable pump.

For the measurement of the consumption of liquids, specifically in the application of fuel consumption of engines on test stands, discontinuously operated systems based on scales are known. They have the advantage of being open systems, whereby the released as well as the recycled amount of fuel is captured by being measured and drawn on when consumption is stated. Such types of scales have been shown to be disadvantageous because they must always be refilled, and as a result, no continuous measuring operation is possible. For this reason, for continuous measurement of fuel consumption, measurement devices are often used that perform a volumetric measurement of the flow rate. With an additional measurement of the density, the fuel mass that was consumed is identified from such, which represents the actually needed measured variable. A direct measurement of consumption of mass that avoids the disadvantage of an additional density measurement can be realized discontinuously with the weighing method, as well as continuously with Coriolis sensors.

For proper operation, modern combustion engines most often require defined flow-rate-independent pressure conditions in the fuel supply line as well as in the perhaps present fuel return line. For this reason, in AT 3 350 U2 or also in AT 6 117 U2 respectively, a unit for flow rate measurement or a unit for calibration of a flow rate measurement with respectively only one pressure sensor downstream of or upstream of the flow rate measurement was proposed, as well as with a pressure stabilization unit for stabilizing the supply-pipe pressure of the mass flow sensor, in order to be able to generate the required small and constant pressure at the attaching point of the consumer. In particular, high-frequency, erratic and pulse-like withdrawals must be attended to quickly. Therefore, for the stabilization of pressure in the fuel measurement in the continuous processes mentioned above, the flow rate sensor pressure regulation devices that regulate the pressure that is dependent on the flow rate at the outlet of the measuring system to a constant outlet pressure are mounted downstream. However, these mechanical pressure regulators act like a “hydraulic diode”, this means that the flowing medium can flow through the regulator in only one direction, namely downstream, and a measuring system that is constructed with such a pressure regulator is not an open system. In the event of a recycling of fuel from the injection system into the measuring system or thermal expansion of the fuel, expensive pressure adjustment devices are provided.

It was the problem of the present invention to propose a process and a device in which in a design that is as simple as possible makes a continuous, precise and also chronologically highly resolvent consumption measurement and the highly dynamic determination of the flow rate value.

As a solution to this problem, the process according to the invention that is described at the beginning is characterized in that at least at one point in time the pressure directly upstream of the flow rate sensor, also the difference of the two pressure values, and based on this difference, a value for the flow rate of the fluid is determined. As a result of this, by consulting a measurement of pressure that is required for the control of pressure anyway, a combination of a very precise long-term flow rate measurement with a highly dynamic determination of the flow rate value by the chronologically resolvable pressure signals is given.

An advantageous process variant provides that continuously, with specifiable chronological resolution, the pressure downstream of the flow rate sensor, the pressure directly upstream of the flow rate sensor, the difference of the two pressure values, and based on this difference a value for the flow rate of the fluid is determined. With that, the resolution of the flow rate value determined from the pressure measurements can be set.

According to a further variant of the invention it is provided that by using a flow rate sensor a median fluid consumption is determined, is linked with the value for the flow rate of the fluid based on the difference of the pressure values and that in this way, a plausibility check of the measurement is performed. The very precise measurement can also be reviewed well within the meaning of the measurement plausibility, because of the determination of the redundant flow rate.

When in accordance with a further embodiment, a median fluid consumption is determined with a flow rate sensor, is linked with the value of the flow rate of the fluid based on the difference of the pressure values and in this way, additional fluid parameters are identified, the possibility exists of consulting the two different flow rate measurements for the identification of additional fluid parameters, for example, density and viscosity.

Advantageously it can also be provided that the signal of the flow rate sensor is subjected to a low-pass filtering, and the signal of the difference of the two pressure values is subjected to a high-pass filtering, and the filtered signals are subsequently assembled into a signal with a large frequency band.

The device for performing a flow rate measurement is, according to the invention, characterized in that an additional pressure sensor is provided directly upstream of the flow rate sensor, whereby both pressure sensors are connected with an evaluation unit in which at least at one point in time, the difference of the values is determined that have been captured by the two pressure sensors and based on this difference a value for the flow rate of the fluid is determined.

In order to be able to determine a higher dynamic value with respect to the signal of the flow rate sensor by the measurement of the difference in pressure, in accordance with an additional characteristic of the invention, pressure sensors with faster step function response are used than those of the flow rate sensor.

Advantageously, it can be provided that in the evaluation unit, the difference between the two pressure values and based on such difference a value for the flow rate of the fluid is determined continuously with a chronological resolution that can be specified.

An additional expansion of the area of application is given for a device in accordance with the invention in which a median fluid consumption is determined in the evaluation unit based on the signals of the flow rate sensor, is linked with the flow rate of the fluid based on the difference of the pressure values, and in this way, fluid parameters are determined.

An additional expansion of the area of application is given for the device in accordance with the invention in which in the evaluation unit from the signals of the flow rate sensor, a median fluid consumption is determined, is linked with the value for the flow rate of the fluid based on the difference of the pressure values and in this way, a plausibility check for the measurement is performed.

In order to achieve a flow rate signal with very high band width, it can further be provided that in the measuring channel of the flow rate sensor a low-pass filter, and in the measuring channel of the signals for the difference of the pressure values, a high-pass filter is realized, whereby in the evaluation unit a signal is assembled from the filtered signals.

Thereby, it is advantageous, when the effective filter characteristics have a constant value up to an upper limit frequency, the value of which is preferably 1.

In the following description, the invention is to be explained in more detail with the examples of embodiments by referring to the enclosed drawing. Thereby, the drawing shows a schematic example of a device in accordance with the invention as continuous fuel consumption measuring system, particularly for engine test stands.

Via a line A and preferably a filling valve 1 that can be actuated electromagnetically, a tank 2 as a reservoir is supplied with liquid, i.e. the fuel. Further, tank 2 is provided with a ventilation 3 and with a fill level sensor 4 that is coupled with filling valve 1.

From tank 2, the fuel is supplied by a preferably controllable fuel pump 6 via a line 8 to continually working flow rate sensor 7, preferably a Coriolis sensor. Subsequently, the fuel reaches the hand-over point via preferably a stop control solenoid 8, at which the engine as consumer (not shown) is connected and to which the fuel is to be available at a specified pressure.

Between flow rate sensor 7 and stop control solenoid 8, a line C branches off, which leads to the regulator inlet of a, for example, mechanic-hydraulic pressure controller 9. Now, via pressure controller 9, dependent on the pressure in the line downstream of flow rate sensor 7, the flow rate through line D is controlled, which branches off between the fuel pump 6 and flow rate sensor 7 from line B, and leads back through pressure controller 9 to fuel tank 2. With that a control circuit with feedback is realized, in which any change in pressure downstream of flow rate sensor 7 with respect to a specifiable value with respect to the pressure controller 9, is transformed into a change in the same direction of that fluid flow, that branches off through line C upstream of flow rate sensor 7 from Line B and is lead back to tank 2 again without flowing through this sensor 7. But with this change in amount, the primary pressure upstream of flow rate sensor 7 is controlled and that, in the opposite direction to the change in pressure downstream of the flow rate sensor 7, so that the deviation in pressure from the selected value can be adjusted quickly and safely. If needed, a selection of pressure at the hand-over point to the consumer could also be realized by a control of pump 6.

Between pump 6 and flow rate sensor 7, a first pressure sensor 10 is provided for determining the pressure in line B. A second pressure sensor 11 is provided for the determination of the pressure in the line system downstream of flow rate sensor 7. The two pressure sensors 10, 11, preferably have a faster step function response than the flow rate sensor 7 that is used. Both pressure sensors 10, 11, are connected with an evaluation unit 12, in which at least at one point in time, the difference of the values determined by the two pressure sensors 10, 11, and based on this difference, a value for the flow rate of the fluid is determined.

Realized by hard-wired circuits or software control, the evaluation unit can, for example, determine the difference of the two pressure values of sensors 10, 11 with a chronological resolution that can be specified, whereby from this difference, a value for the flow rate of the fluid can be determined. Even the determination of a median fluid consumption in evaluation unit 12 from the signals of flow rate sensor 7 and its linkage with the flow rate value based on the difference of the pressure values for the plausibility check for the measurement could be provided.

On the other hand, the possibility is also given that in the evaluation unit 12, from the signals of flow rate sensor 7 a median fluid consumption is determined, is linked with the value for the flow rate of the fluid based on the difference of the pressure values of sensors 10, 11, and in such a way, additional fluid parameters are determined, for example, the density or the viscosity of the fluid.

Advantageously, in the measuring channel of the flow rate sensor 7, a low-pass filter and in the measuring channel of the signal for the difference of the pressure values of sensors 10, 11, a high-pass filter are realized, In evaluation unit 12, a signal can then be assembled with high band width from the filtered individual signals. Thereby, it is advantageous when the effective filter characteristics have a constant value up to an upper limit frequency, the value of which is preferably 1.

1. A process for continuous measurement of a dynamic fluid consumption, particularly fuel consumption, with a continuously working flow rate sensor (7) with variable pressure drop, preferably a mass flow sensor, whereby the pressure downstream of the flow rate sensor (7) is determined and used for controlling the transportation of fluid, wherein at least a one point in time, also the pressure directly upstream of flow rate sensor (7), the difference of the two pressure values and based on this difference, a value for the flow rate of the fluid is determined.

2. The process according to claim 1, including continuously, with specifiable chronological resolution, the pressure downstream of the flow rate sensor (7), the pressure directly upstream of the flow rate sensor (7), the difference of the two pressure values and based on this difference, a value for the flow rate of the fluid is determined.

3. The process according to claim 1, wherein the flow rate sensor (7), a median fluid consumption is determined, is linked with the value for the flow rate of the fluid based on the difference of the pressure values, and in such a way a plausibility check for the measurement is performed.

4. The process according to claim 1, wherein the flow rate sensor (7), a median fluid consumption is determined and is linked with the value for the flow rate of the fluid based on the difference of the pressure values, and that in such a way, additional fluid parameters are determined.

5. The process according to claim 1, wherein the signal of the flow rate sensor (7) is subjected to a low-pass filtering and the signal of the difference between the two pressure values is subjected to a high-pass filtering and the filtered signals are subsequently assembled into one signal of large frequency bandwidth.

6. A device for continuous measurement of a dynamic fluid consumption, particularly fuel, comprising a tank (2), if needed, a conditioning system, as well as preferably a controllable pump (6), a continually working flow rate sensor (7) for the liquid, preferably a Coriolis sensor, as well as a pressure sensor (11) directly downstream of the flow rate sensor, whose outlet is connected with at least in one control unit for the fluid flow, for example a controllable pump (6), characterized in that an additional pressure sensor (10) is provided directly upstream of the flow rate sensor (7), whereby both pressure sensors (10, 11) are connected with an evaluation unit (12), in which at least at one point in time the difference of the values determined by the two pressure sensors (10, 11) is determined, and based on this difference a value for the flow rate of the fluid is determined.

7. The device according to claim 6, wherein the pressure sensors (10, 11) a with faster step function response are used than those of flow rate sensor (7).

8. The device according to claim 6, wherein an evaluation unit (12) continuously, with specifiable chronological resolution the difference of the two pressure values, and based on this difference, a value for the flow rate of the fluid is determined.

9. The device according claim 6, wherein evaluation unit (12) from the signals of flow rate sensor (7) a medium fluid consumption is determined, is linked with the value for the flow rate of the fluid based on the difference of the pressure values, and in such a way the plausibility check for the measurement is performed.

10. The device according to claim 6, wherein the evaluation unit (12) from the signals of flow rate sensor (7) a medium fluid consumption is identified, is linked with the value for the flow rate of the fluid based on the difference of the pressure values, and that in such a way, additional fluid parameters are determined.

11. The device according to claim 6, wherein the measuring channel of flow rate sensor (7) a low-pass filter and in the measuring channel of the signal for the difference of the pressure values a high-pass filter is realized, whereby in evaluation unit (12) a signal is assembled from the filtered signals.

12. The device according to claim 11, wherein the effective filter characteristics have a constant value up to an upper limit frequency, the value of which is preferably 1.
